(19) United States
(12) Patent Application Publication
(10) Pub. No.: US 2026/0121841 A1
(43) Pub. Date: Apr. 30, 2026

(54) SYSTEMS AND METHODS FOR HIGH-PERFORMANCE QUANTUM-SAFE KEY MANAGEMENT

(71) Applicant: JPMORGAN CHASE BANK, N.A., New York, NY (US)

(72) Inventors: Marco PISTOIA, Amawalk, NY (US); Charles LIM, Singapore (SG); Albert HUANG, Singapore (SG); Cassey LIANG, Singapore (SG); Omar AMER, New York, NY (US); Randy LAI, Singapore (SG); Jefferson CHU, Singapore (SG)

(21) Appl. No.: 19/086,622

(22) Filed: Mar. 21, 2025

Related U.S. Application Data
(60) Provisional application No. 63/713,338, filed on Oct. 29, 2024.

(51) Int. Cl. H04L 9/08; H04L 9/14; H04L 9/32

(52) U.S. Cl. CPC H04L 9/0852; H04L 9/14; H04L 9/3221

(57) ABSTRACT

Systems and methods for high-performance quantum-safe key management are disclosed. A method may include: (1) receiving, by a client service router, a client request for an operation involving a key from a client computer program; (2) authenticating, by the client service router and using a credentials operations service, the client request; (3) verifying, by the client service router and using a credentials operating service, permission for the client request; (4) routing, by the client service router, the request to a cryptoprocessor, wherein the cryptoprocessor is configured to execute the operation; (5) receiving, by the client service router, a result of the execution of the operation from the cryptoprocessor; and (6) returning, by the client service router, the result to the client computer program.

### RELATED APPLICATIONS

This application claims priority to, and the benefit of, U.S. Provisional Patent Application Ser. No. 63/713,338, filed Oct. 29, 2024, the disclosure of which is hereby incorporated, by reference, in its entirety.

### BACKGROUND OF THE INVENTION

### 1. Field of the Invention

Embodiments relate to systems and methods for high-performance quantum-safe key management.

### 2. Description of the Related Art

Emerging quantum technologies pose a significant threat to current cryptographic systems. This could lead to the compromise of cryptographic safeguards for sensitive data in critical sectors such as finance, healthcare, and government.

### SUMMARY OF THE INVENTION

Systems and methods for high-performance quantum-safe key management are disclosed. According to one embodiment, a method may include: (1) receiving, by a client service router, a client request for an operation involving a key from a client computer program; (2) authenticating, by the client service router and using a credentials operations service, the client request; (3) verifying, by the client service router and using a certificate authority operations service, permission for the client request; (4) routing, by the client service router, the request to a cryptoprocessor, wherein the cryptoprocessor may be configured to execute the operation; (5) receiving, by the client service router, a result of the execution of the operation from the cryptoprocessor; and (6) returning, by the client service router, the result to the client computer program.

In one embodiment, the operation comprising generating the key.

In one embodiment, the key may be stored in a key management service server, and the operation may include encrypting a message with the key, signing the message with the key, or decrypting a ciphertext with the key.

In one embodiment, the credentials operations service authenticates the client request using public key authentication.

In one embodiment, the credentials operations service authenticates the client request using zero-knowledge proofs.

In one embodiment, the certificate authority operations service verifies the permission based on a policy.

According to another embodiment, a method may include: (1) retrieving, by a first quantum key distribution (QKD) service at a first node, a QKD key and a key identifier for the QKD key from a first QKD device; (2) sending, by the first QKD service, the key identifier to a second QKD service at a second node; (3) retrieving, by the second QKD service, the QKD key from a second QKD device at the second node; (4) confirming, by the first QKD service and the second QKD service, that the QKD retrieved by the first QKD service and the QKD key retrieved by the second QKD service are the same; (5) storing, by the first QKD service or the second QKD service, the QKD key; (6) generating, by a cryptoprocessor, a new key from the QKD key; (7) logging, by the cryptoprocessor, the generation of the new key with a key management logger; and (8) returning, by the cryptoprocessor, a status of the generated key to the first QKD service and/or the second QKD service.

In one embodiment, the first QKD device and the second QKD devices are synchronized.

In one embodiment, the first QKD service retrieves the QKD key and the key identifier for the QKD key as a key-value pair.

In one embodiment, the step of confirming, by the first QKD service and the second QKD service, that the QKD retrieved by the first QKD service and the QKD key retrieved by the second QKD service are the same may include: hashing, by the first QKD service, the QKD key retrieved by the first QKD service; hashing, by the second QKD service, the QKD key retrieved by the first QKD service; at least one of the first QKD service and the second QKD service communicating its hash to the other; and comparing, by the QKD service that received the hash, that the hashes are the same.

In one embodiment, the method may also include: deleting, by the first QKD service and the second QKD service, the QKD keys in response to the QKD keys not matching.

In one embodiment, the QKD key may be stored in a database at its node.

In one embodiment, the method may also include: storing, by the cryptoprocessor, the QKD key in an ownerless QKD container.

According to another embodiment, a method may include: (1) receiving, at a key derivation function (KDF) service and from a quantum key distribution (QKD) service, an input seed and a request for key expansion; (2) generating, by the KDF service, an output key using key expansion and input seed; (3) sending, by the KDF service, a store request with the output key to a cryptoprocessor; (4) storing, by the cryptoprocessor, the output key to an ownerless KDF container; (5) logging, by, the cryptoprocessor, the storing using a key management logger; and (6) returning, by the cryptoprocessor, a result of the key expansion to the KDF service.

In one embodiment, the method may also include: receiving, by the cryptoprocessor, a request for the output key; and moving, by the cryptoprocessor, the output key from the ownerless KDF container to a used key container.

In one embodiment, the method may also include: storing, by the cryptoprocessor, a plurality of random numbers in an ownerless cryptographic objects container; receiving, by the cryptoprocessor, a request for one of the plurality of random numbers; and moving, by the cryptoprocessor, one of the plurality of random numbers from the ownerless cryptographic objects container to a used cryptographic objects container.

In one embodiment, the input seed may be received from a QKD key service.

In one embodiment, the input seed may be received from a quantum random number generator.

In one embodiment, the method may also include: storing, by the cryptoprocessor, non-cryptographic objects in another container.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for high-performance quantum-safe key management according to an embodiment;

FIG. 2 illustrates a method for processing a client request according to an embodiment;

FIG. 3 illustrates a method for performing a QKD service according to an embodiment;

FIG. 4 illustrates a method for performing a KDF service according to an embodiment; and

FIG. 5 depicts an exemplary computing system for implementing aspects of the present disclosure.

### DETAILED DESCRIPTION OF PREFERRED EMBODIMENTS

Embodiments relate to systems and methods for high-performance quantum-safe key management.

Embodiments may provide a key management service (KMS) that handles tasks such as key generation, distribution, storage, lifecycle management, and selected cryptographic operations. Embodiments may support quantum-safe algorithms, such as those approved by the National Institute of Standards and Technology (NIST), and key generation via Quantum Key Distribution (QKD).

In embodiments, the KMS may be developed in a programming language that provides memory safety and reliability. An example of such programming language is Rust, which is endorsed by NIST. The programming language may provide features, such as ownership-based memory management, enforced at compile time, which minimizes runtime overhead and results in predictable, high-performance execution; robust concurrency primitives and guarantees thread safety at compile time, enabling efficient and secure concurrent programming; and allows for fine-grained control over system resources, including memory layout and allocation, allowing optimization for performance-critical sections of code.

Embodiments may provide high performance by providing a centralized architecture, removing overhead of managing consistency for distributed architecture, by optimizing synchronization and communication between sub-components, by fine tuning system parameters (e.g., number of replications and partitions), by optimizing the cryptoprocessor backend (e.g., by using SIMD on hardware), by providing loosely coupled sub-components to increase parallelism between sub-components, etc.

Embodiments may include two cryptoprocessor backends. For example, a cryptoprocessor backend may be located inside a hardware secure module (HSM) and may be used for applications that require high-security. The cryptographic operations may be performed exclusively inside the HSM, which provides strict physical and logical security and access control. The drawback of this backend is its speed is limited to the HSM's hardware performance.

The other cryptoprocessor backend may be located in a backend server. This may be used for applications that prioritize performance and able to tolerate a lower security guarantee.

The cryptoprocessor backend that is used may depend on the security policy assigned to each cryptographic object, which may be determined during the object creation.

Embodiments may provide the key generation using keys supplied from QKD devices, generated through key derivation functions (KDF), such as NIST-approved KDFs, such as: KDF-PRF (NIST SP 800-108), PBKDF2 (NIST SP 800-132), etc., and post-quantum cryptography (PQC) key generation (Module-Lattice-Based Key-Encapsulation Mechanism (ML-KEM) (FIPS 203)), etc.

Embodiments may provide key distribution, key lifecycle management (e.g., activate, revoke, automatic key rotation, etc.), cryptographic operations (e.g., symmetric algorithm: AES-based (encrypt, decrypt, MAC generation), PQC: ML-KEM, Module-Lattice-Based Digital Signature Standard (ML-DSA) (FIPS 204), and KDF), and secret data storage.

As used herein, a service (e.g., client service, certificate authority service, crypto operations service, credentials operation service, background service, KDF service, QKD key service, etc.) refer to modules, such as computer program, scripts, etc. that are executed by hardware, such as computer processors.

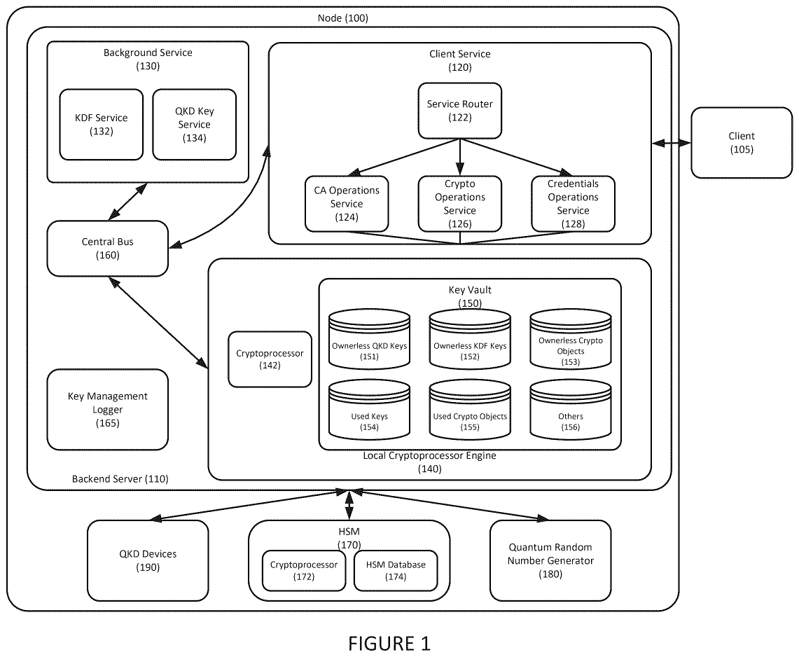

Referring to FIG. 1, a system for high-performance quantum-safe key management is disclosed according to an embodiment. A system may include client 105, which may be a client device (e.g., a physical and/or cloud-based server, a computer, a smart phone, etc.) that may interface with node 100, in particular, with client service 120. Backend server 110 may include background service 130, client service 120, central bus 160, and local cryptoprocessor engine 140.

Client service 120 may include service router 122, certificate authority operations service 124, cryptographic operations service 126, and credentials operations service 128.

In one embodiment, client service 120 may be any logical program that may directly interface with client 105. Examples of client services 120 may include authenticating user identity, authorizing a user's permission, issuing new certificate for new client, routing a client's request to the correct cryptoprocessor backend (e.g., cryptoprocessor 142 or 172), etc.

Cryptoprocessor 142 and 172 may execute code to perform cryptographic operations, to log cryptographic operations in key management logger 165, etc. Cryptoprocessors 142 and 172 may be software modules or may be hardware components.

Client service 120 may not perform business logic operations, e.g., cryptographic operation requested.

Client service 120 may be co-located in the same server as local cryptoprocessor engine 140 to reduce communication latency.

Service router 122 may receive a request from client 105 and may route it to service router 122, certificate authority operations service 124, cryptographic operations service 126, and/or credentials operations service 128 as necessary. Service router 122 may be a software module. In one embodiment, a client request may first be routed to credentials operations service 128 which may authenticate and authorize the client's identity and permission. Next, it may be routed to either certificate authority operations service 124 or to cryptographic operations service 126 depending on type of request. For example, if the request is to create a new client, it may be routed to the former. If the request is to encrypt message using key stored in the KMS, it may be routed to the latter.

Certificate authority operations service 124 may be any service related to certificate authority management, such as issuing (e.g., generating and signing a new client's certificate that includes the new client's public key and information to identify the new client) and managing digital certificates (e.g., maintaining list of active, expired or revoked certificates, verifying certificate's validity, etc.) This serves to establish root of trust in the Public Key Infrastructure (PKI)-based authentication, which is used in this KMS system.

For example, certificate authority operations service 124 may issue the new certificate when adding a new client 105 in the system. The certificate may then be used to authenticate client 105.

Cryptographic operations service 126 may interact with local cryptoprocessor engine 140 to process client 105's request. Cryptographic operations service 126 may be a hardware module or a software module. Cryptographic operations service 126 may route the client request to the correct cryptoprocessor (e.g., cryptoprocessor 142 or 172). For example, if the cryptographic object requested is in HSM 170, cryptographic operations service 126 may route the client request to cryptoprocessor 172 in HSM 170. If the cryptographic object is located in local cryptoprocessor engine 140, cryptographic operations service 126 may route the client request to cryptoprocessor 165 in local cryptoprocessor engine 140.

Credentials operations service 128 may authenticate client 105's identity and may perform permission verifications. Credentials operations service 128 may be a hardware module or a software module. Credentials operations service 128 may authenticate client 105's identity and client 105's permissions. Authenticating client 105's identity ensures that client 105 is whoever it claims to be. Credentials operations service 128 may receive two things from client 105: their digital certificate and a signed message. Only users that possess the private key corresponding to public key contained in the digital certificate will be able to generate a valid signature.

In one embodiment, credentials operations service 128 may store policies for an organization. Illustrative examples of policies may include whether client 105 is authorized to generate a key, to use his or her name to encrypt and sign, or only encrypt, etc. The policies for clients may be set when the client is added, and may be modified as is necessary and/or desired.

Authorizing client 105's permission ensures that client 105 has permission of whatever operation they requested. For example, if a user requested to encrypt a message M using key K, this service will check if this user indeed has the permission to use the key K.

Node 100 may further include background service 130. Background service 130 may include KDF service 132, and QKD key service 134. Background service 130 is a service that will run periodically to perform specific tasks. For example, QKD key service 134 may retrieve QKD keys from QKD device 190 and may store them in a container in, for example, key vault 150 and/or HSM database 174 Background service 130 may run on the same physical server as the local cryptoprocessor engine 140 to reduce communication latency.

QKD device 190 may be a physical QKD device, such as a laser and photodetector pair. The laser at one QKD device 190 may emit a very weak light (i.e., a photon) that is sent over an optical fiber to another QKD device 190 the other device, which will then measure the light using the photodetector. The output of the photodetector is an electrical signal that may be interpreted as binary and further processed by a classical microprocessor. This further processing includes stuff such as error correction, privacy amplification, etc.

The end result of the post-processing is symmetric keys at both QKD devices 190 that can be accessed by users through APIs, such as a get_key and a get_key_by_id API.

Thus, QKD devices 190 may be abstracted as a kind of distributed database, that may be queried using get_key( ) API where it will select based on its policy and entries of (key value, key id). The database can also be queried using get_key_by_id( ) API where it will return the key value corresponding to this key id.

KDF service 132 may expand a cryptographic key. KDF service 132 may be a hardware module or a software module. For example, a KDF takes two inputs (on top of the configuration parameters such as number of iterations, output key length, etc. which will be pre-configured before the service start): (1) a primary secret (input key), and (2) a salt (a random seed). These two inputs will deterministically set the KDF's output, i.e., given the same primary secret and salt, it will result in the same output key.

The primary secret and the random seed may be provided by the QKD key service 134. Once the primary secret and salt have been distributed using QKD, a KDF operation may be performed locally at each node (e.g., physical location) so the final output key will not be transferred from one physical location to the other.

By seeding this input from QKD services, embodiments may achieve the following: (1) secure key distribution as the distribution of the primary secret and salt is achieved using QKD; and (2) improved key generation rate for application that requires lower security level.

KDF service 132 may be used to generate fresh key which may be stored in the ownerless KDF keys container 152. Local cryptoprocessor engine 140 or HSM 170 may also perform KDF operations on user's key, in which the output of this KDF may be stored in used keys container 154 container or in HSM 170, respectively.

QKD key service 134 may retrieve a key from QKD device 190 and may store it in key vault 150 of backend server. A second QKD device (not shown) may be provided with a second node (not shown).

Node 100 may include central bus 160, which may provide interfaces for client service 120, background service 130, local cryptoprocessor engine 140, Hardware Secure Module (HSM) 170, and Quantum Random Number Generator 180.

Central bus 160 may coordinate activity between different services or between different threads for parallel software to avoid race condition.

Local cryptoprocessor engine 140 may include key management logger 165 and key vault 150. Local cryptoprocessor engine 140 may be a hardware module or a software module. Key management logger may log transactions of keys. Key vault 150 may store keys in one or more containers according to a key status. For example, QKD keys that have not been associated with a client may be stored in ownerless QKD key container 151, KDF keys that have not been associated with a client may be stored in ownerless KDF key container 152, cryptographic objects that have not been associated with a client may be stored in ownerless crypto objects container 153, used QKD and KDF keys may be stored in used keys container 154, used cryptographic objects may be stored in used crypto objects container 155, and other keys and objects that do not fit into one of the other containers may be stored in other container 156.

Transactions may include any operation requested by user. The server may also store non-key object, such as secret data. Furthermore, the transactions can also include key deletion, key rotation, etc.

Cryptographic objects may include secret data (a string of byte), certificate (like X.509), random number, etc.

Other keys may include third-party keys, e.g., user provided keys, etc.

Other objects may include data objects (general purpose storage), etc.

HSM 170 may be a physical device that may store cryptographic keys securely and to perform cryptographic operations on the keys. Examples may include standard cryptographic operations such as encryption, decryption, signing, verification, MAC generation, key generation, key storage, etc.

HSM 170 may include cryptoprocessor 172 and HSM database 174. HSM database 174 may include containers to store ownerless QKD keys, ownerless KDF keys, ownerless crypto objects, used keys, used cryptographic objects, and other keys, similar to how they may be stored in key vault 150.

Quantum random number generator 180 may provide high quality random numbers for cryptographic operations. The elements that receive random number include local cryptoprocessor engine 140 as some cryptographic operations require random number as input, or it can also be provided to user when requested (in this case, it will be returned through client service 120).

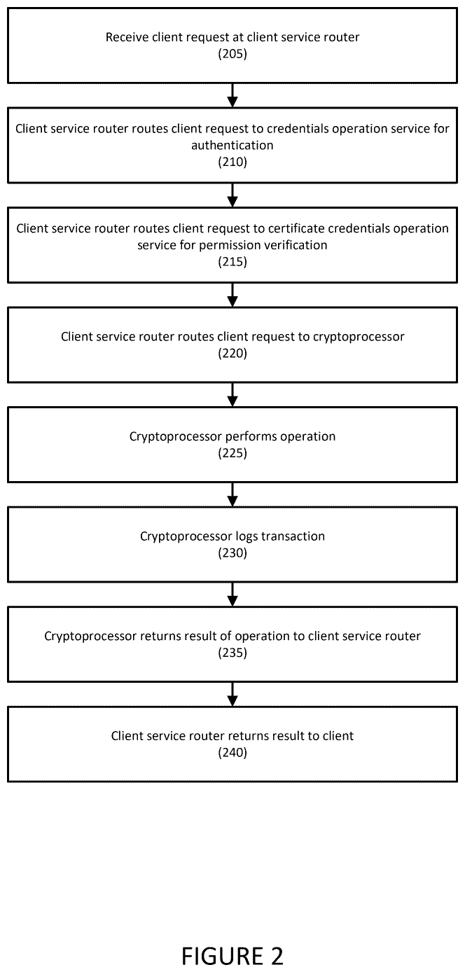

Referring to FIG. 2, a method for processing a client request is disclosed according to an embodiment.

In step 205, a client service router in client service module may receive a client request. For example, the request may be for a key, encrypt a message with a key that is stored inside the KMS server, to decrypt a ciphertext with a key that is stored inside the KMS server, to sign a message with a key that is stored inside the KMS server, etc.

In step 210, the client service router may route the client request to a credentials operations service to authenticate the client request. The authentication may be based on, for example, PKI-authentication which includes the usage of a pair of public and private key to identify a user. In another embodiment, authentication may be based on zero-knowledge proofs. For example, zero-knowledge password proof (ZKPP) or zero-knowledge succinct non-interactive argument of knowledge (zk-SNARK) may be used. In another embodiment, an entity can be verified using their public key (which, as the name suggest, will be made public). Only the entity that possesses the corresponding private key can generate valid signature.

When a client wants to request for certificate for itself, the client may generate private and public key pair. The private key is kept secret to the client only.

The client may present the server with its public key and additional information, such as name, organization name, country, etc. This step may require a manual authentication. For example, a human may be needed to verify the identity of the client using their ID card to associate the public key with the client.

The server may generate a digital certificate, which may include the public key and additional information and return it to client 105. This digital certificate may also be recorded by the certificate authority operations service for future verification purposes.

In step 215, the client service router may route the client request to a credentials operating service for client verification and/or permission verification. Permission verification may be implemented by checking the policy associated with the client and the requested cryptographic objects. For example, metadata related to the key may be stored. The metadata may include the information of which clients are allowed to perform an operation using this key. Furthermore, certain keys may only be used for certain applications, for example, exclusively for encryption/decryption and not for signing/verification.

Cryptographic operations may be performed in the credentials operations service for authentication.

In step 220, the client service router may route the client request to a cryptoprocessor. The client service router may be the first to receive client's request. The crypto operations service may contain the logic to route the request to the correct cryptoprocessor.

In step 225, the cryptoprocessor may perform the operation in the client request. For example, the cryptoprocessor may request that an operation to encrypt a message, M, with a key having a key identifier, K_id. The cryptoprocessor may first retrieve the key value K that is identified by key identifier K_id. The cryptoprocessor may then perform the encryption operation. The output ciphertext will be returned to the crypto operations service to be returned to the client.

In step 230, the cryptoprocessor may log the encryption operation using a key management logger.

In step 235, the cryptoprocessor may return a result of operation to client service router. For example, for encryption operation, it may return ciphertext; for decryption operation, it may return plaintext; for signing operation, it may return the signature; for information query operation, it may return the requested information, such as validity of the key; etc.

In step 240, the client service router may return the result to the client. For example, after receiving ciphertext corresponding to encryption of a message, a first client at a first node may send a ciphertext to a second client that is physically separated from the first client at a second node. The second client may request the KMS server at the second node to decrypt this ciphertext to obtain the original message. By doing this, the key will be kept secure as it is stored securely inside the KMS server, and all of the operations are also performed inside here.

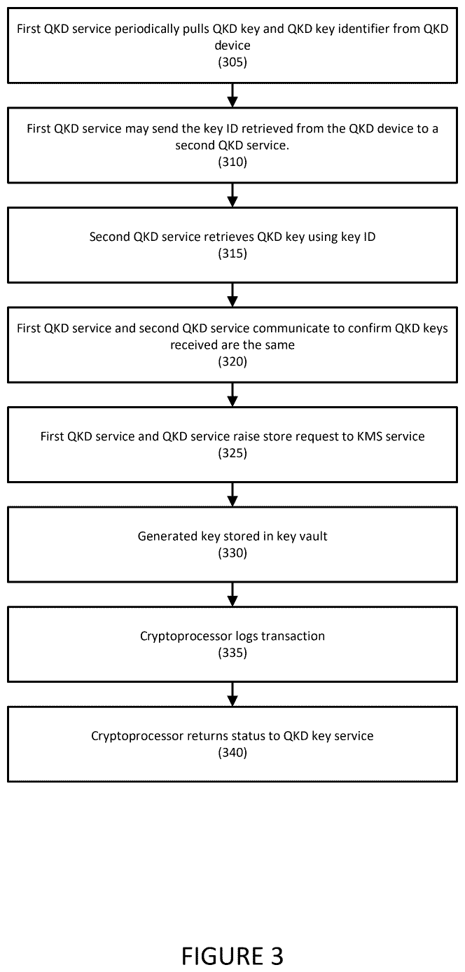

Referring to FIG. 3, a method for performing a QKD service is provided according to an embodiment. In one embodiment, the QKD device pairs may automatically perform quantum key exchange once they are powered.

In step 305, a first QKD service at a first node may periodically pull keys from a QKD device at the first node. For example, a first QKD service may pull the keys using, for example, a get_key API. This API may return a key-value pair (i.e., a pair of a key and a value), in which the “value” is the QKD key itself and the “key” is an identifier that uniquely identifies the QKD key.

In step 310, the first QKD service may send the pulled key ID to a second QKD service at a second node. The second QKD service may be part of a QKD service pair with the first QKD service.

In step 315, the second QKD service may retrieve the QKD key using the key ID. For example, the second QKD service may call the get_key_by_ID API with the key ID.

In one embodiment, the second QKD service may retrieve the QKD key from a QKD device at its own node. The QKD devices at the two nodes are symmetrical.

The QKDs key are secure random bit strings that are symmetrical between the first QKD service and the second QKD service. This symmetric random bit string can be used as input to various cryptography protocol, especially ones that require symmetric keys, such as AES encryption, HMAC, etc.

In step 320, the first QKD service and the second QKD service communicate to confirm that the QKD keys received are the same. This is for notifying the QKD key service that the store operation succeeds for a handshake mechanism. For example, if, for some reason, the QKD key store at the first node succeeds but fails at the second node, then the second node must notify the first node that the operation failed, and the first node must then delete the corresponding key to ensure consistency between the two nodes.

In one embodiment, the first QKD service and the second QKD service may hash their respective QKD keys, and may compare the result of the hashes to make sure that they are the same.

In step 325, the first QKD service and/or the second QKD service may raise a store request to the cryptoprocessor to store the QKD key(s). The store request is an API which take the QKD key and its associated metadata and store them in a local database, such as in a key vault, in a HSM, etc. The store request may take in parameters such as key value, label, QKD device origins, etc.

In step 330, the cryptoprocessor may store the cryptographic key(s) in a key vault. In one embodiment, the cryptographic key(s) may be stored in a container in the key vault, such as an ownerless QKD keys container.

In step 335, the cryptoprocessor may log the generation of the cryptographic key, or any other cryptographic operation, using a key management logger.

In step 340, the cryptoprocessor may return a status of the generated key to the first and/or second QKD key service.

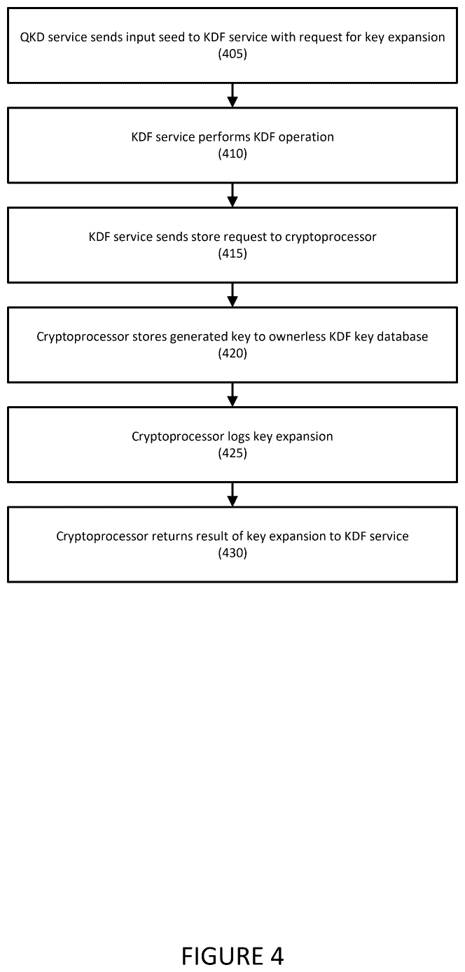

Referring to FIG. 4, a method for performing a KDF service is provided according to an embodiment.

In step 405, a QKD service may send an input seed to a KDF service with a request for key expansion. For example, if the output key from KDF must be distributed between node A and node B, then the seed must come from a QKD key service. However, if the output key does not need to be distributed between two nodes, e.g., the key is used locally at a single node, then the seed may be provided by a quantum random number generator.

In step 410, the KDF service may perform a KDF operation, such as a key expansion operation, using the input seed.

In step 415, the KDF service may periodically send a store request to a cryptoprocessor. The store request from KDF service may include the output key from the key expansion operation.

In step 420, the cryptoprocessor may store the output key to ownerless KDF container.

In step 425, the cryptoprocessor may log the generation of the output key using a key management logger.

In step 430, the cryptoprocessor may return a result of the generation of the output key to the KDF service.

The keys may be stored in different containers. For example, when a client requests a new key (e.g., a user key), the cryptoprocessor will take a key from either the ownerless QKD keys container or the ownerless KDF keys container, and move it to the client keys container. Alternatively, the client may provide the key itself.

When the new key is requested, the cryptoprocessor may move the key to a used key container.

When a client requests a random number, the cryptoprocessor will take a random number from the ownerless crypto objects container and move it to the used crypto objects container.

When a client wants to store non-cryptographic objects, such as generic data, they may be stored in the other container.

Examples of systems and methods for quantum key distribution are disclosed in U.S. patent application Ser. No. 18/174,768 and U.S. patent application Ser. No. 18/305,039, the disclosure of which are hereby incorporated, by reference, in their entireties.

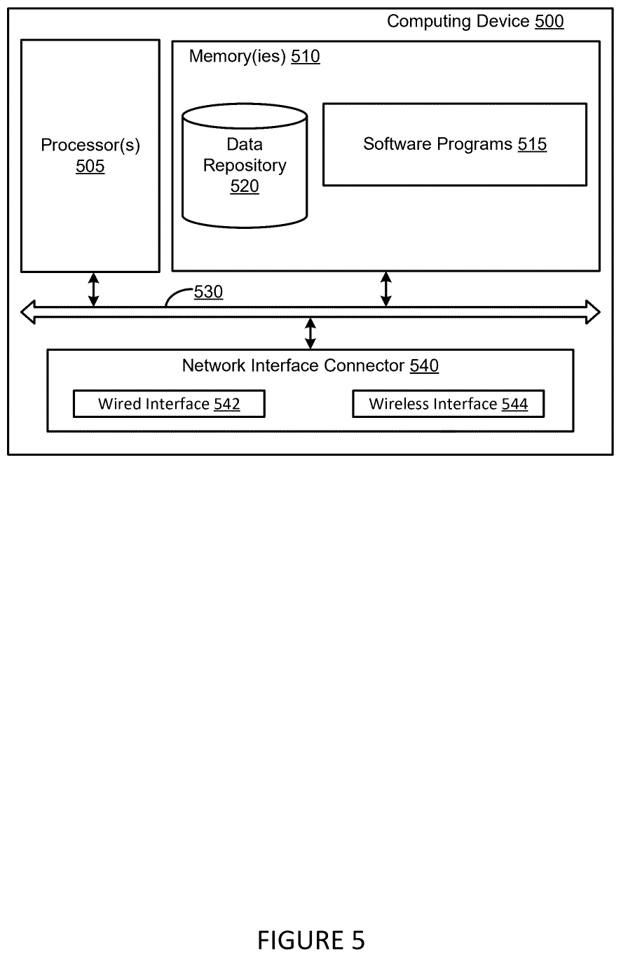

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a client service router, a client request for an operation involving a key from a client computer program;
authenticating, by the client service router and using a credentials operations service, the client request;
verifying, by the client service router and using a credentials operating service, permission for the client request;
routing, by the client service router, the request to a cryptoprocessor, wherein the cryptoprocessor is configured to execute the operation;
receiving, by the client service router, a result of the execution of the operation from the cryptoprocessor; and
returning, by the client service router, the result to the client computer program.

2. The method of claim 1, wherein the operation comprising generating the key.

3. The method of claim 1, wherein the key is stored in a key management service server, and the operation comprises encrypting a message with the key, signing the message with the key, or decrypting a ciphertext with the key.

4. The method of claim 1, wherein the credentials operations service authenticates the client request using public key authentication.

5. The method of claim 1, wherein the credentials operations service authenticates the client request using zero-knowledge proofs.

6. The method of claim 1, wherein the credentials operating service verifies the permission based on a policy.

7. A method, comprising:
retrieving, by a first quantum key distribution (QKD) service at a first node, a QKD key and a key identifier for the QKD key from a first QKD device;
sending, by the first QKD service, the key identifier to a second QKD service at a second node;
retrieving, by the second QKD service, the QKD key from a second QKD device at the second node;
confirming, by the first QKD service and the second QKD service, that the QKD retrieved by the first QKD service and the QKD key retrieved by the second QKD service are the same;
storing, by the first QKD service or the second QKD service, the QKD key;
generating, by a cryptoprocessor, a new key from the QKD key;
logging, by the cryptoprocessor, the generation of the new key with a key management logger; and
returning, by the cryptoprocessor, a status of the generated key to the first QKD service and/or the second QKD service.

8. The method of claim 7, wherein the first QKD device and the second QKD devices are synchronized.

9. The method of claim 7, wherein the first QKD service retrieves the QKD key and the key identifier for the QKD key as a key-value pair.

10. The method of claim 7, wherein the step of confirming, by the first QKD service and the second QKD service, that the QKD retrieved by the first QKD service and the QKD key retrieved by the second QKD service are the same comprises:
hashing, by the first QKD service, the QKD key retrieved by the first QKD service;
hashing, by the second QKD service, the QKD key retrieved by the first QKD service;
at least one of the first QKD service and the second QKD service communicating its hash to the other; and
comparing, by the QKD service that received the hash, that the hashes are the same.

11. The method of claim 7, further comprising:
deleting, by the first QKD service and the second QKD service, the QKD keys in response to the QKD keys not matching.

12. The method of claim 7, wherein the QKD key is stored in a database at its node.

13. The method of claim 7, further comprising:
storing, by the cryptoprocessor, the QKD key in an ownerless QKD container.

14. A method, comprising:
receiving, at a key derivation function (KDF) service and from a quantum key distribution (QKD) service, an input seed and a request for key expansion;
generating, by the KDF service, an output key using key expansion and input seed;
sending, by the KDF service, a store request with the output key to a cryptoprocessor;
storing, by the cryptoprocessor, the output key to an ownerless KDF container;
logging, by, the cryptoprocessor, the storing using a key management logger; and
returning, by the cryptoprocessor, a result of the key expansion to the KDF service.

15. The method of claim 14, further comprising:
receiving, by the cryptoprocessor, a request for the output key; and
moving, by the cryptoprocessor, the output key from the ownerless KDF container to a used key container.

16. The method of claim 14, further comprising:
storing, by the cryptoprocessor, a plurality of random numbers in an ownerless cryptographic objects container;
receiving, by the cryptoprocessor, a request for one of the plurality of random numbers; and
moving, by the cryptoprocessor, one of the plurality of random numbers from the ownerless cryptographic objects container to a used cryptographic objects container.

17. The method of claim 14, wherein the input seed is received from a QKD key service.

18. The method of claim 14, wherein the input seed is received from a quantum random number generator.

19. The method of claim 14, further comprising:
storing, by the cryptoprocessor, non-cryptographic objects in an others container.
